(19) United States
(12) Patent Application Publication
(10) Pub. No.: US 2014/0240836 A1
(43) Pub. Date: Aug. 28, 2014

(54) WAVELENGTH VARIABLE INTERFERENCE FILTER, OPTICAL FILTER DEVICE, OPTICAL MODULE, AND ELECTRONIC APPARATUS

(71) Applicant: Seiko Epson Corporation, Tokyo (JP)

(72) Inventors: Susumu SHINTO, Shimosuwa (JP); Tomoki SAKASHITA, Chino (JP)

(73) Assignee: Seiko Epson Corporation, Tokyo (JP)

(21) Appl. No.: 14/187,714

(22) Filed: Feb. 24, 2014

(30) Foreign Application Priority Data
Feb. 22, 2013 (JP) 2013-032936

(51) Int. Cl. G02B 26/00

(52) U.S. Cl. CPC G02B 26/001
USPC 359/578

(57) ABSTRACT

The thickness of a first drive electrode is greater than the sum of the thickness of a first reflective film and the thickness of a first conductive film, the first drive electrode extends from the surface of a fixed substrate to the surface of the outer edge portion of the first conductive film and is in contact with the first conductive film, the thickness of a second drive electrode is greater than the sum of the thickness of a second reflective film and the thickness of a second conductive film, and the second drive electrode extends from the surface of a movable substrate to the surface of the outer edge portion of the second conductive film and is in contact with the second conductive film.

### BACKGROUND

1. Technical Field

The present invention relates to a wavelength variable interference filter, an optical filter device, an optical module, and an electronic apparatus.

2. Related Art

An apparatus which uses a wavelength variable interference filter and measures the spectrum of incoming light is known.

A variable interference device described in JP-A-1-94312 has a configuration in which a reflective film functions as a driving electrode and a configuration in which a reflective film functions as an electrostatic capacitance monitoring electrode.

In the structure of JP-A-1-94312, in order for the reflective film to function as the driving electrode or the electrostatic capacitance monitoring electrode, it is necessary to wire a connection electrode which is connected to the reflective film.

In order for the reflective film to have a light transmission characteristic and a light reflection characteristic, the reflective film is formed to have a thickness smaller than the thickness of the connection electrode.

However, when a thick connection electrode and a thin reflective film are formed in an overlapping manner, metal atoms of the thin reflective film are diffused toward the connection electrode due to external factors, such as heat, or change over time, and there is concern about disconnection.

### SUMMARY

An advantage of some aspects of the invention is to solve the problems described above, and the invention can be implemented as the following forms or application examples.

### Application Example 1

A wavelength variable interference filter according to this application example includes a first substrate, a second substrate which is arranged to face the first substrate, a first reflective film which is provided on the first substrate, reflects a part of incoming light, and transmits a part of incoming light, a second reflective film which is provided on the second substrate and is arranged to face the first reflective film reflecting a part of incoming light and transmitting a part of incoming light, a first conductive film which is laminated on the first reflective film, a second conductive film which is laminated on the second reflective film, a first connection electrode which is provided on the first substrate and is electrically connected to the first conductive film on the first substrate, and a second connection electrode which is provided on the second substrate and is electrically connected to the second conductive film on the second substrate, in which the thickness of the first connection electrode is greater than the sum of the thickness of the first reflective film and the thickness of the first conductive film, the first connection electrode extends from the surface of the first substrate to the surface of the outer edge portion of the first conductive film and is in contact with the first conductive film, the thickness of the second connection electrode is greater than the sum of the thickness of the second reflective film and the thickness of the second conductive film, and the second connection electrode extends from the surface of the second substrate to the surface of the outer edge portion of the second conductive film and is in contact with the second conductive film.

With this configuration, the first connection electrode extends from the surface of the first substrate to the surface of the outer edge portion of the first conductive film and is in contact with the first conductive film, and the thickness of the first connection electrode is greater than the sum of the thickness of the first reflective film and the thickness of the first conductive film.

The second connection electrode extends from the surface of the second substrate to the surface of the outer edge portion of the second conductive film and is in contact with the second conductive film, and the thickness of the second connection electrode is greater than the sum of the thickness of the second reflective film and the thickness of the second conductive film.

In this way, the first reflective film and the second reflective film having a small thickness and the first connection electrode and the second connection electrode having a large thickness are connected together through the first conductive film and the second conductive film.

The first conductive film and the second conductive film are provided, thereby ensuring electrical connection between the first reflective film and the second reflective film and electrical connection between the first reflective film and the second reflective film in the connection portion. The first conductive film and the second conductive film prevent metal atoms from being diffused from the first reflective film and the second reflective film to the first connection electrode and the second connection electrode in the connection portion, and can suppress disconnection of wiring.

From this, it is possible to reliably provide electrical conduction between the first reflective film and the first connection electrode and electrical conduction between the second reflective film and the second connection electrode, and to improve connection reliability of wiring.

### Application Example 2

In the wavelength variable interference filter according to the above-described application example, it is preferable that at least one of the first connection electrode and the second connection electrode is in contact with the entire circumference of the outer edge portion of the first conductive film or the second conductive film.

With this configuration, the first connection electrode and the second connection electrode are in contact with and cover the entire circumference of the outer edge portion of each of the first conductive film and the second conductive film.

From this, it is possible to decrease electrical resistance in wiring connection, and to perform satisfactory connection.

### Application Example 3

In the wavelength variable interference filter according to the above-described application example, it is preferable that the first conductive film and the second conductive film are transparent conductive films.

With this configuration, the first conductive film and the second conductive film are transparent conductive films.

From this, it is possible to form the conductive film without interference with the light transmission characteristics of the first reflective film and the second reflective film.

### Application Example 4

In the wavelength variable interference filter according to the above-described application example, it is preferable that the materials of the first conductive film and the second conductive film are materials selected from indium-based oxide, tin-based oxide, zinc-based oxide, and a mixture thereof.

With this configuration, the materials of the first conductive film and the second conductive film are materials selected from indium-based oxide, tin-based oxide, zinc-based oxide, and a mixture thereof.

These materials are used as the first conductive film and the second conductive film, thereby effectively preventing diffusion from the first reflective film and the second reflective film to the first connection electrode and the second connection electrode. With the use of these materials, it is possible to protect the first reflective film and the second reflective film from a chemical in the manufacturing process.

### Application Example 5

In the wavelength variable interference filter according to the above-described application example, it is preferable that the materials of the first reflective film and the second reflective film are Ag or an alloy primarily containing Ag.

With this configuration, the materials of the first reflective film and the second reflective film are Ag or an alloy primarily containing Ag.

When Ag or an alloy primarily containing Ag is used as the first reflective film and the second reflective film, it is possible to obtain excellent characteristics in both light transmission and light reflection.

### Application Example 6

In the wavelength variable interference filter according to the above-described application example, it is preferable that the second substrate includes a movable portion which is provided with the second reflective film, and a holding portion which is provided outside the movable portion in plan view when the second substrate is viewed in a substrate thickness direction, has a thickness smaller than the thickness of the movable portion, and retreatably holds the movable portion.

With this configuration, the second substrate includes the movable portion which is provided with the second reflective film, and the holding portion which is provided outside the movable portion, has a thickness smaller than the thickness of the movable portion, and holds the movable portion.

In this structure, the holding portion is bent by external force, thereby displacing the movable portion. This displacement causes change in the gap between the first reflective film and the second reflective film, whereby it is possible to easily form a wavelength variable interference filter in which the gap between the reflective films is variable.

### Application Example 7

A wavelength variable interference filter according to this application example includes a reflective film which reflects a part of incoming light and transmits a part of incoming light, a conductive film which is laminated on the reflective film, and a connection electrode which is electrically connected to the conductive film, in which the thickness of the connection electrode is greater than the sum of the thickness of the reflective film and the thickness of the conductive film, and the connection electrode is in contact with the surface of the outer edge portion of the conductive film in an overlapping manner.

With this configuration, the conductive film which is laminated on the reflective film is provided, the thickness of the connection electrode is greater than the sum of the thickness of the reflective film and the thickness of the conductive film, and the connection electrode is in contact with the surface of the outer edge portion of the conductive film in an overlapping manner.

The conductive film is provided, thereby ensuring electrical connection between the reflective film and the reflective film in the connection portion. The conductive film can prevent metal atoms from being diffused from the reflective film to the connection electrode in the connection portion, and can suppress disconnection of wiring.

From this, it is possible to reliably provide electrical conduction between the reflective film and the connection electrode, and to improve connection reliability of wiring.

### Application Example 8

An optical filter device according to this application example includes a wavelength variable interference filter having a first substrate, a second substrate which is arranged to face the first substrate, a first reflective film which is provided on the first substrate, reflects a part of incoming light, and transmits a part of incoming light, a second reflective film which is provided on the second substrate and is arranged to face the first reflective film reflecting a part of incoming light and transmitting apart of incoming light, a first conductive film which is laminated on the first reflective film, a second conductive film which is laminated on the second reflective film, a first connection electrode which is provided on the first substrate and is electrically connected to the first conductive film on the first substrate, and a second connection electrode which is provided on the second substrate and is electrically connected to the second conductive film on the second substrate, and a housing which stores the wavelength variable interference filter, in which the thickness of the first connection electrode is greater than the sum of the thickness of the first reflective film and the thickness of the first conductive film, the first connection electrode extends from the surface of the first substrate to the surface of the outer edge portion of the first conductive film and is in contact with the first conductive film, the thickness of the second connection electrode is greater than the sum of the thickness of the second reflective film and the thickness of the second conductive film, and the second connection electrode extends from the surface of the second substrate to the surface of the outer edge portion of the second conductive film and is in contact with the second conductive film.

With this configuration, the first connection electrode extends from the surface of the first substrate to the surface of the outer edge portion of the first conductive film and is in contact with the first conductive film, and the thickness of the first connection electrode is greater than the sum of the thickness of the first reflective film and the thickness of the first conductive film.

The second connection electrode extends from the surface of the second substrate to the surface of the outer edge portion of the second conductive film and is in contact with the second conductive film, and the thickness of the second connection electrode is greater than the sum of the thickness of the second reflective film and the thickness of the second conductive film.

In this way, the first reflective film and the second reflective film having a small thickness and the first connection electrode and the second connection electrode having a large thickness are connected together through the first conductive film and the second conductive film.

The first conductive film and the second conductive film can prevent atoms from being diffused from the first reflective film and the second reflective film to the first connection electrode and the second connection electrode, and can suppress disconnection of wiring.

From this, it is possible to reliably provide electrical conduction between the first reflective film and the first connection electrode and electrical conduction between the second reflective film and the second connection electrode, to improve connection reliability of wiring, and to improve reliability of the optical filter device.

Since the wavelength variable interference filter is stored in the housing, for example, it is possible to protect the wavelength variable interference filter from impact or the like during transportation. It is also possible to prevent a foreign substance from being stuck to the first reflective film and the second reflective film of the wavelength variable interference filter.

### Application Example 9

An optical module according to this application example includes a first substrate, a second substrate which is arranged to face the first substrate, a first reflective film which is provided on the first substrate, reflects a part of incoming light and transmits a part of incoming light, a second reflective film which is provided on the second substrate and is arranged to face the first reflective film reflecting a part of incoming light and transmitting a part of incoming light, a first conductive film which is laminated on the first reflective film, a second conductive film which is laminated on the second reflective film, a first connection electrode which is provided on the first substrate and is electrically connected to the first conductive film on the first substrate, a second connection electrode which is provided on the second substrate and is electrically connected to the second conductive film on the second substrate, and a detection unit which detects light extracted by the first reflective film and the second reflective film, in which the thickness of the first connection electrode is greater than the sum of the thickness of the first reflective film and the thickness of the first conductive film, the first connection electrode extends from the surface of the first substrate to the surface of the outer edge portion of the first conductive film and is in contact with the first conductive film, the thickness of the second connection electrode is greater than the sum of the thickness of the second reflective film and the thickness of the second conductive film, and the second connection electrode extends from the surface of the second substrate to the surface of the outer edge portion of the second conductive film and is in contact with the second conductive film.

With this configuration, the first connection electrode extends from the surface of the first substrate to the surface of the outer edge portion of the first conductive film and is in contact with the first conductive film, and the thickness of the first connection electrode is greater than the sum of the thickness of the first reflective film and the thickness of the first conductive film.

The second connection electrode extends from the surface of the second substrate to the surface of the outer edge portion of the second conductive film and is in contact with the second conductive film, and the thickness of the second connection electrode is greater than the sum of the thickness of the second reflective film and the thickness of the second conductive film.

In this way, the first reflective film and the second reflective film having a small thickness and the first connection electrode and the second connection electrode having a large thickness are connected together through the first conductive film and the second conductive film.

The first conductive film and the second conductive film can prevent atoms from being diffused from the first reflective film and the second reflective film to the first connection electrode and the second connection electrode, and can suppress disconnection of wiring.

From this, it is possible to reliably provide electrical conduction between the first reflective film and the first connection electrode and electrical conduction between the second reflective film and the second connection electrode, to improve connection reliability of wiring, and to improve reliability of the optical module. Therefore, it is possible to carry out light amount detection with high precision by the optical module.

### Application Example 10

An electronic apparatus according to this application example includes a wavelength variable interference filter having a first substrate, a second substrate which is arranged to face the first substrate, a first reflective film which is provided on the first substrate, reflects a part of incoming light and transmits a part of incoming light, a second reflective film which is provided on the second substrate and is arranged to face the first reflective film reflecting a part of incoming light and transmitting apart of incoming light, a first conductive film which is laminated on the first reflective film, a second conductive film which is laminated on the second reflective film, a first connection electrode which is provided on the first substrate and is electrically connected to the first conductive film on the first substrate, and a second connection electrode which is provided on the second substrate and is electrically connected to the second conductive film on the second substrate, and a control unit which controls the wavelength variable interference filter, in which the thickness of the first connection electrode is greater than the sum of the thickness of the first reflective film and the thickness of the first conductive film, the first connection electrode extends from the surface of the first substrate to the surface of the outer edge portion of the first conductive film and is in contact with the first conductive film, the thickness of the second connection electrode is greater than the sum of the thickness of the second reflective film and the thickness of the second conductive film, and the second connection electrode extends from the surface of the second substrate to the surface of the outer edge portion of the second conductive film and is in contact with the second conductive film.

With this configuration, the first connection electrode extends from the surface of the first substrate to the surface of the outer edge portion of the first conductive film and is in contact with the first conductive film, and the thickness of the first connection electrode is greater than the sum of the thickness of the first reflective film and the thickness of the first conductive film.

The second connection electrode extends from the surface of the second substrate to the surface of the outer edge portion of the second conductive film and is in contact with the second conductive film, and the thickness of the second connection electrode is greater than the sum of the thickness of the second reflective film and the thickness of the second conductive film.

In this way, the first reflective film and the second reflective film having a small thickness and the first connection electrode and the second connection electrode having a large thickness are connected together through the first conductive film and the second conductive film.

The first conductive film and the second conductive film can prevent atoms from being diffused from the first reflective film and the second reflective film to the first connection electrode and the second connection electrode, and can suppress disconnection of wiring.

From this, it is possible to reliably provide electrical conduction between the first reflective film and the first connection electrode and electrical conduction between the second reflective film and the second connection electrode, to improve connection reliability of wiring, and to improve reliability of the electronic apparatus. Therefore, the electronic apparatus can carry out processing with high precision on the basis of light extracted by the wavelength variable interference filter.

### BRIEF DESCRIPTION OF THE DRAWINGS

The invention will be described with reference to the accompanying drawings, wherein like numbers reference like elements.

FIG. 1 is a schematic view showing a configuration of a spectroscopic measurement apparatus of a first embodiment.

FIG. 2 is a plan view of a wavelength variable interference filter according to the first embodiment.

FIG. 3 is a sectional view of the wavelength variable interference filter according to the first embodiment.

FIG. 4 is an enlarged view of a B portion of FIG. 3.

FIG. 5 is a plan view when a fixed substrate of the wavelength variable interference filter according to the first embodiment is viewed from a movable substrate side.

FIG. 6 is a plan view when the movable substrate of the wavelength variable interference filter according to the first embodiment is viewed from the fixed substrate side.

FIGS. 7A to 7E are explanatory views showing a manufacturing process of the fixed substrate of the wavelength variable interference filter according to the first embodiment.

FIGS. 8A to 8E are explanatory views showing a manufacturing process of the movable substrate of the wavelength variable interference filter according to the first embodiment.

FIG. 9 is an explanatory view showing a bonding process of the wavelength variable interference filter according to the first embodiment.

FIG. 10 is a plan view showing a modification example of a shape of a first drive electrode in the first embodiment.

FIGS. 11A and 11B are schematic sectional views showing a modification example of a connection state of a first drive electrode in the first embodiment.

FIG. 12 is a sectional view showing a schematic configuration of an optical filter device in a second embodiment.

FIG. 13 is a schematic view showing a configuration of a colorimetric apparatus as an electronic apparatus in a third embodiment.

FIG. 14 is a schematic view showing a configuration of a gas detection apparatus as an electronic apparatus in a fourth embodiment.

FIG. 15 is a block diagram showing a control system of the gas detection apparatus as an electronic apparatus in the fourth embodiment.

FIG. 16 is a schematic view showing a configuration of a food analysis apparatus as an electronic apparatus in a fifth embodiment.

FIG. 17 is a schematic view showing a configuration of a spectroscopic camera as an electronic apparatus in a sixth embodiment.

### DESCRIPTION OF EXEMPLARY EMBODIMENTS

Hereinafter, an embodiment of the invention will be described referring to the drawings. In the respective drawings of the following description, the dimensional ratio of each member is appropriately changed so as to allow each member to be of recognizable size.

### First Embodiment

### Configuration of Spectroscopic Measurement Apparatus

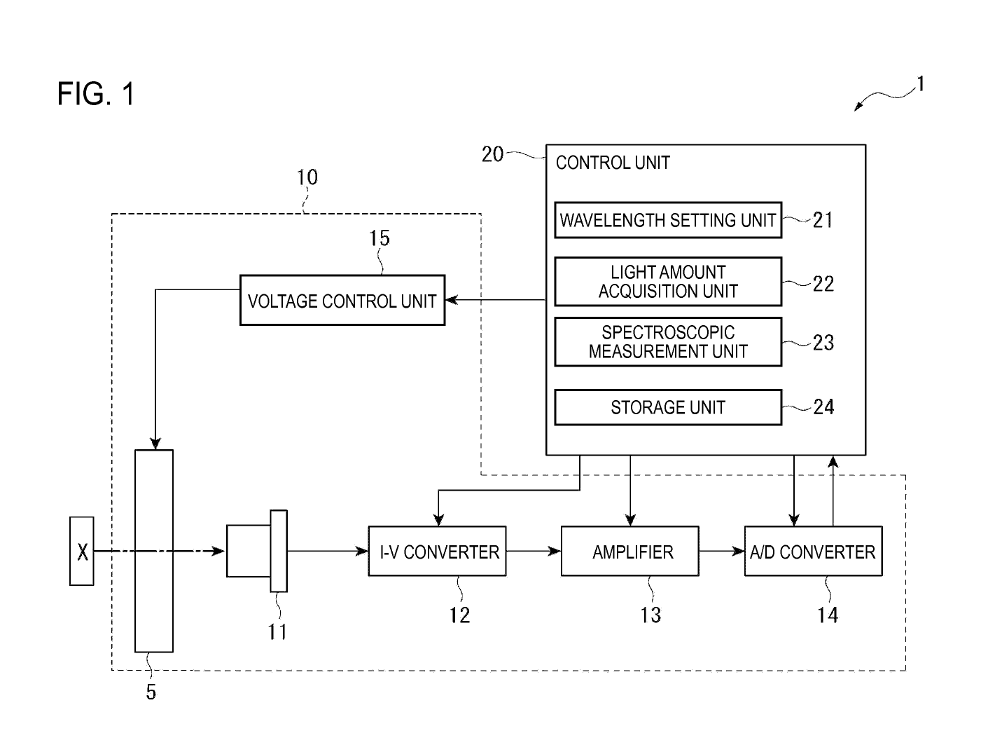

FIG. 1 is a schematic view showing a configuration of a spectroscopic measurement apparatus according to a first embodiment of the invention.

A spectroscopic measurement apparatus 1 is an electronic apparatus according to the invention, and is an apparatus which measures the spectrum of light to be measured on the basis of light to be measured reflected by an object X to be measured. In this embodiment, although an example where light to be measured reflected by the object X to be measured is measured will be described, when a luminous body, such as a liquid crystal panel, is used as an object X to be measured, for example, light emitted from the luminous body may be used as the light to be measured.

As shown in FIG. 1, the spectroscopic measurement apparatus 1 includes an optical module 10 and a control unit 20.

### Configuration of Optical Module

The optical module 10 includes a wavelength variable interference filter 5, a detector 11, an I-V converter 12, an amplifier 13, an A/D converter 14, and a voltage control unit 15.

The detector 11 receives light transmitted through the wavelength variable interference filter 5 of the optical module 10, and outputs a detection signal (current) according to the intensity of received light.

The I-V converter 12 converts the detection signal input from the detector 11 to a voltage value, and outputs the voltage value to the amplifier 13.

The amplifier 13 amplifies a voltage (detection voltage) according to the detection signal input from the I-V converter 12.

The A/D converter 14 converts the detection voltage (analog signal) input from the amplifier 13 to a digital signal, and outputs the digital signal to the control unit 20.

The voltage control unit 15 applies a voltage to a drive electrode (described below) of the wavelength variable interference filter 5. The wavelength variable interference filter 5 transmits light having a target wavelength according to the applied voltage.

### Configuration of Wavelength Variable Interference Filter

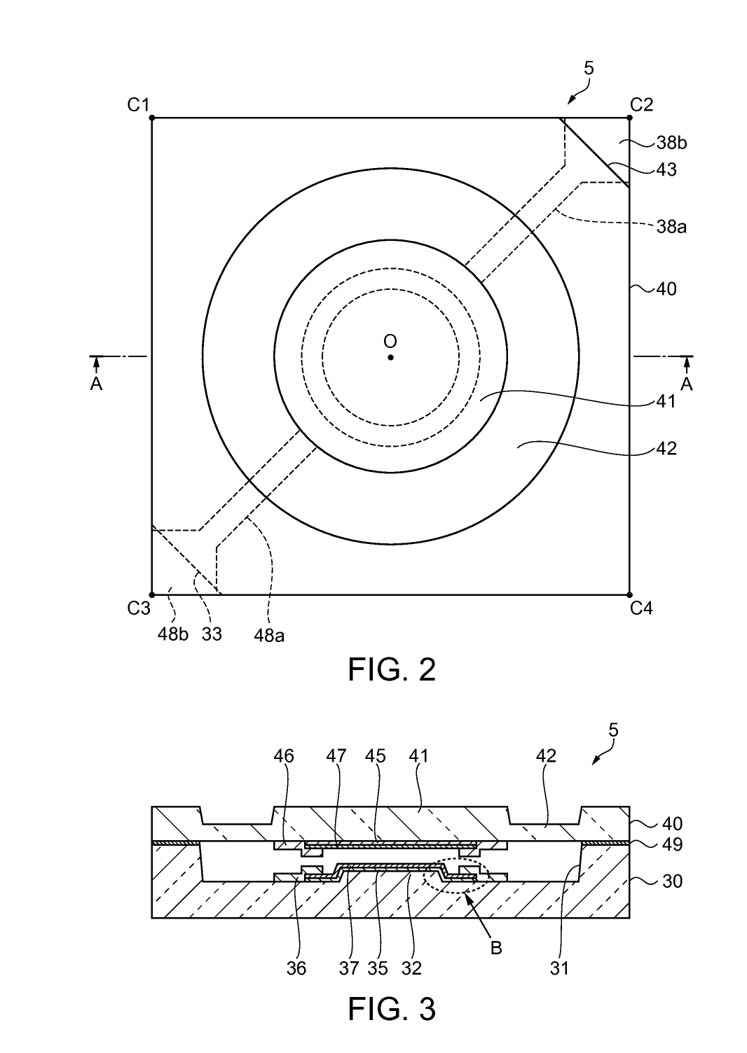

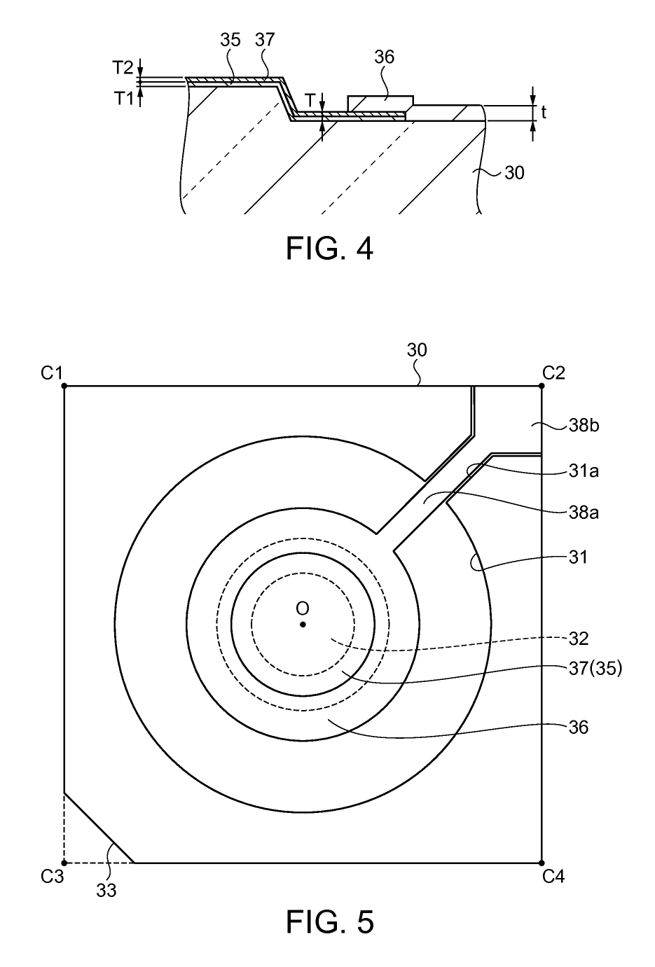

FIG. 2 is a plan view of the wavelength variable interference filter according to this embodiment, and FIG. 3 is a sectional view taken along the line II-II of FIG. 2. FIG. 4 is an enlarged view of a B portion of FIG. 3.

The wavelength variable interference filter 5 of this embodiment is a so-called Fabry-Perot etalon. The wavelength variable interference filter 5 includes a fixed substrate (first substrate) 30 and a movable substrate (second substrate) 40. The fixed substrate 30 and the movable substrate 40 are formed of, for example, various kinds of glass, such as quartz glass, soda-lime glass, crystalline glass, lead glass, potassium glass, borosilicate glass, and non-alkali glass, crystal, silicon, or the like.

The fixed substrate 30 and the movable substrate 40 are bonded together by, for example, a bonding film 49 made of a plasma polymerized film or the like primarily containing siloxane, and are integrated as a single body.

A first reflective film 35 is provided on the fixed substrate 30, a second reflective film 45 is provided on the movable substrate 40, and the first reflective film 35 and the second reflective film 45 are arranged to face each other through the gap between the reflective films. A first conductive film 37 is laminated on the first reflective film 35, and a second conductive film 47 is laminated on the second reflective film 45. The first conductive film 37 and the second conductive film 47 are respectively formed of the same size as the first reflective film 35 and the second reflective film 45. The wavelength variable interference filter 5 is provided with an electrostatic actuator which is used to change the amount of the gap between the reflective films. The electrostatic actuator is constituted by a first drive electrode 36 (first connection electrode) provided on the fixed substrate 30 and a second drive electrode 46 (second connection electrode) provided on the movable substrate 40. A pair of first drive electrode 36 and second drive electrode 46 face each other through the gap between the electrodes, and function as an electrostatic actuator. The amount of the gap between the electrodes may become greater or smaller than the amount of the gap between the reflective films.

The first drive electrode 36 is formed in a ring shape. Although a configuration of the first drive electrode 36 is not particularly limited, for example, an electrode in which an underlayer is a Cr film and an Au film as an electrode layer is laminated on the Cr film may be used. In this case, the thickness of the Cr film is about 10 nm, and the thickness of the Au film is 100 nm to 200 nm. Instead of the Cr film of the underlayer, a film, such as Ti, NiCr, or TiW, may be used. For the first drive electrode 36, a transparent conductive film, such as ITO (indium tin oxide), may be used.

The first drive electrode 36 is in contact with the entire circumference of the outer edge of the first conductive film 37 formed on the first reflective film 35. The first reflective film 35 is formed of Ag or an alloy primarily containing Ag, and the thickness of the first reflective film 35 is 10 nm to 80 nm.

Ag or an alloy primarily containing Ag is used as the first reflective film 35, thereby obtaining excellent characteristics in both light transmission and light reflection.

The first conductive film 37 is formed of a transparent conductive film, such as indium-based oxide, tin-based oxide, or zinc-based oxide. Specifically, ITO, ICO (cerium-doped indium oxide), AZO (aluminum-doped zinc oxide), SnO, or the like is used. DLC (diamond-like carbon) may be used. The thickness of the first conductive film 37 is 5 nm to 30 nm.

In this way, it is possible to form the first conductive film 37 without interference with the light transmission characteristic of the first reflective film 35.

As shown in FIG. 4, if the sum of the thickness T1 of the first reflective film 35 and the thickness T2 of the first conductive film 37 is T (T=T1+T2), and the thickness of the first drive electrode 36 is t, the relationship of T <t is established.

For this reason, even if the first drive electrode 36 is covered from the top of the first conductive film 37, since a step from the fixed substrate 30 is small, the first drive electrode 36 can be formed in the end portion of the first conductive film 37, and thus, disconnection does not occur.

In this way, the first reflective film 35, the first conductive film 37, and the first drive electrode 36 are electrically connected together, thereby providing electrical conduction.

The first conductive film 37 is provided between the first drive electrode 36 and the first reflective film 35 in the connection portion, whereby it is possible to prevent Ag atoms of the first reflective film 35 from being diffused to the Cr film and the Au film of the first drive electrode 36, and to suppress disconnection of connecting wiring.

Similarly to the first drive electrode 36, the second drive electrode 46 is formed in a ring shape, and although a configuration of the second drive electrode 46 is not particularly limited, for example, an electrode in which an underlayer is a Cr film and an Au film as an electrode layer is laminated on the Cr film may be used. The Cr film and the Au film are formed to have the same thickness as the first drive electrode 36.

The second drive electrode 46 is in contact with the entire circumference of the outer edge of the second conductive film 47 formed on the second reflective film 45. Similarly to the first reflective film 35, the second reflective film 45 is formed of Ag or an alloy primarily containing Ag, and the thickness of the second reflective film 45 is 10 nm to 80 nm.

The second conductive film 47 is formed of a transparent conductive film, such as indium-based oxide, tin-based oxide, or zinc-based oxide. Specifically, ITO, ICO (cerium-doped indium oxide), AZO (aluminum-doped zinc oxide), SnO, or the like is used. DLC (diamond-like carbon) may be used. The thickness of the second conductive film 47 is 5 nm to 30 nm.

In this way, it is possible to form the second conductive film 47 without interference with the light transmission characteristic of the second reflective film 45.

A relationship is established that the sum of the thickness of the second reflective film 45 and the thickness of the second conductive film 47 is smaller than the thickness of the second drive electrode 46.

For this reason, even if the second drive electrode 46 is formed from the top of the second conductive film 47, since a step from the movable substrate 40 is small, the second drive electrode 46 can be sufficiently formed in the end portion of the second conductive film 47, and thus, disconnection does not occur.

In this way, the second reflective film 45, the second conductive film 47, and the second drive electrode 46 are electrically connected together, thereby providing electrical conduction.

The second conductive film 47 is provided between the second drive electrode 46 and the second reflective film 45 in the connection portion, it is possible to prevent Ag atoms of the second reflective film 45 from being diffused to the Cr film and the Au film of the second drive electrode 46, and to suppress disconnection of connecting wiring.

The above-described wavelength variable interference filter 5 has a configuration in which the first reflective film 35 and the first drive electrode 36, and the second reflective film 45 and the second drive electrode 46 are electrically connected together to allow static electricity charged on the first reflective film 35 and the second reflective film 45 to escape outside.

### Configuration of Fixed Substrate

FIG. 5 is a plan view when the fixed substrate 30 is viewed from the movable substrate 40 side.

The fixed substrate 30 is formed to have a thickness enough to prevent the fixed substrate 30 from being bent due to electrostatic attraction by the electrostatic actuator or internal stress of a film member formed on the fixed substrate 30.

As shown in FIG. 5, the fixed substrate 30 includes a concave portion 31 formed by, for example, etching or the like and a convex portion 32 in which the first reflective film 35 is arranged. A notch portion 33 is provided in a part (vertex C3) of the outer edge of the fixed substrate 30, and an electrode pad 48b of the movable substrate 40 (described below) is exposed to the surface of the wavelength variable interference filter 5 from the notch portion 33.

The concave portion 31 is formed in a ring shape centering on a filter center point O of the fixed substrate in plan view in the thickness direction of the fixed substrate 30. The convex portion 32 is formed to protrude from the center portion of the concave portion 31 toward the movable substrate 40 in plan view in the thickness direction of the fixed substrate 30.

A bottom surface of the concave portion 31 becomes an electrode installation surface on which the first drive electrode 36 of the electrostatic actuator is arranged. A protruding front end surface of the convex portion 32 becomes a reflective film installation surface on which the first reflective film 35 is arranged.

The fixed substrate 30 is provided with an electrode lead-out groove 31a which extends from the concave portion 31 toward a vertex C2 of the fixed substrate 30. The electrode lead-out groove 31a is formed to have the same depth as the concave portion 31.

The first drive electrode 36 which is provided along a virtual circle centering on the filter center point O is provided on the bottom surface of the concave portion 31. The first drive electrode 36 is formed concentrically to the convex portion 32.

The fixed substrate 30 is provided with a lead-out electrode 38a which extends from the outer edge of the first drive electrode 36 to the vertex C2 along the electrode lead-out groove 31a toward the vertex C2. A front end portion of the lead-out electrode 38a forms an electrode pad 38b which is connected to the voltage control unit 15.

The first drive electrode 36, the lead-out electrode 38a, and the electrode pad 38b have a structure in which the underlayer is the Cr film, and the Au film as an electrode layer is laminated on the Cr film.

If the Au film is used as an electrode layer, since terminal connectivity when connecting wavelength variable interference filter 5 to the voltage control unit 15 is satisfactory, and conductivity is satisfactory, it is possible to suppress an increase in electrical resistance. The Cr film having high adhesion to Au and high adhesion to a glass substrate (fixed substrate 30) is used as the underlayer, whereby it is possible to prevent separation of the first drive electrode 36, the lead-out electrode 38a, and the electrode pad 38b.

In this embodiment, although a two-layered electrode in which the underlayer is the Cr film and the electrode layer is the Au film has been illustrated, a different metal film (Al or the like) which has adhesion to the glass substrate and has conductivity may be used in a single layer.

An insulating film which ensures insulation between the first drive electrode 36 and the second drive electrode 46 may be laminated on the first drive electrode 36.

In this embodiment, although a configuration in which the single first drive electrode 36 is provided on the bottom surface of the concave portion 31 is described, for example, a configuration (dual electrode configuration) in which two electrodes are provided to become a concentric circle centering on the filter center point O, or the like may be made.

The convex portion 32 is substantially formed in a columnar shape coaxially to the concave portion 31, and includes the reflective film installation surface facing the movable substrate 40.

The first reflective film 35 is provided to extend from the reflective film installation surface to the bottom surface of the concave portion 31. The first conductive film 37 is formed on the first reflective film 35.

The first drive electrode 36 is connected on the entire circumference of the outer edge portion of the outer circumference of the first conductive film 37 formed on the first reflective film 35, and the first reflective film 35, the first conductive film 37, and the first drive electrode 36 are electrically connected together, thereby providing electrical conduction. In this way, since the first drive electrode 36 is in contact with the entire circumference of the outer edge portion of the first conductive film 37, it is possible to decrease electrical resistance in wiring connection, and to perform satisfactory connection.

### Configuration of Movable Substrate

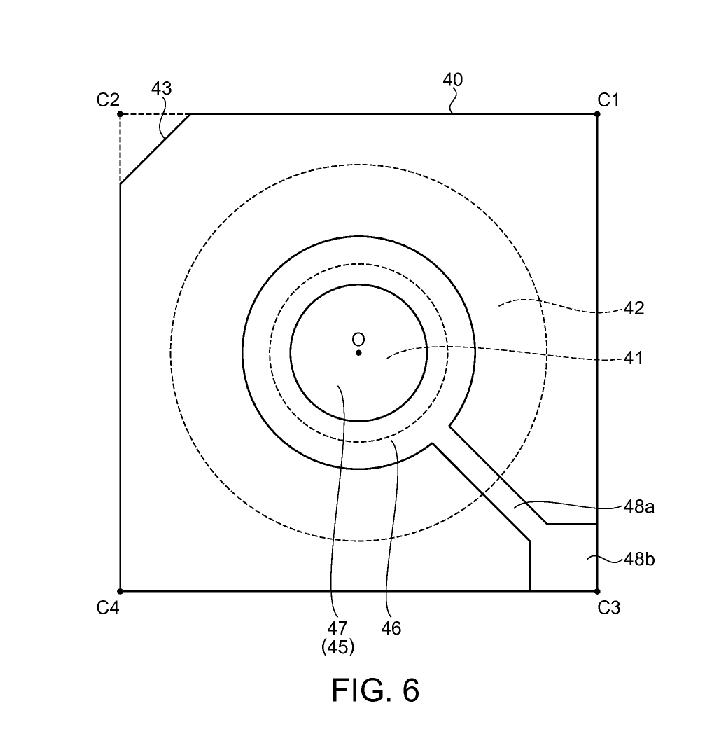

FIG. 6 is a plan view when the movable substrate 40 is viewed from the fixed substrate 30 side. Vertexes C1, C2, C3, and C4 of the movable substrate 40 in FIG. 6 correspond to the vertexes C1, C2, C3, and C4 of the fixed substrate 30 shown in FIG. 5.

As shown in FIGS. 3 and 6, in plan view in the thickness direction of the movable substrate 40, the movable substrate 40 includes a circular movable portion 41 centering on the filter center point O, and a holding portion 42 which is coaxial to the movable portion 41 and holds the movable portion 41.

As shown in FIG. 6, the movable substrate 40 is provided with a notch portion 43 at the vertex C2, and as described above, the electrode pad 38b of the fixed substrate 30 is exposed from the notch portion 43.

The movable portion 41 is formed to have a thickness greater than the holding portion 42. In plan view in the thickness direction of the movable substrate 40, the movable portion 41 is formed to have a diameter greater than at least the diameter of the outer edge of the reflective film installation surface. The second reflective film 45, the second conductive film 47, and the second drive electrode 46 are provided on the surface of the movable portion 41 facing the fixed substrate 30.

An anti-reflection film may be formed on the surface opposite to the surface of the movable portion 41 facing the fixed substrate 30.

As shown in FIG. 6, in plan view in the thickness direction of the movable substrate 40, the second drive electrode 46 is provided in a region facing the first drive electrode 36 outside the second reflective film 45.

The second drive electrode 46 is provided with a lead-out electrode 48a which extends toward the vertex C3. A front end portion of the lead-out electrode 48a forms an electrode pad 48b which is connected to the voltage control unit 15.

In the electrode configuration as described above, as shown in FIG. 3, an electrostatic actuator is formed by an arc region where the first drive electrode 36 and the second drive electrode 46 overlap each other.

The second drive electrode 46, the lead-out electrode 48a, and the electrode pad 48b have a structure in which the underlayer is the Cr film, and the Au film as an electrode layer is laminated on the Cr film.

When the Au film is used as an electrode layer, since terminal connectivity when connecting the wavelength variable interference filter 5 to the voltage control unit 15 is satisfactory, and conductivity is satisfactory, it is possible to suppress an increase in electrical resistance. Cr which has high adhesion to Au and high adhesion to a glass substrate (movable substrate 40) is used as the underlayer, whereby it is possible to prevent separation of the second drive electrode 46, the lead-out electrode 48a, and the electrode pad 48b.

In this embodiment, although a two-layered electrode in which the underlayer is the Cr film and the electrode layer is the Au film has been illustrated, a different metal film (Al or the like) which has adhesion to the glass substrate and has conductivity may be used in a single layer.

An insulating film which ensures insulation between the first drive electrode 36 and the second drive electrode 46 may be laminated on the second drive electrode 46.

In this embodiment, although a configuration in which the single second drive electrode 46 is provided is described, for example, a configuration (dual electrode configuration) in which two electrodes are provided to become a concentric circle centering on the filter center point O may be made.

The second reflective film 45 is made of the same material as the first reflective film 35. The second conductive film 47 is formed on the second reflective film 45.

The second drive electrode 46 is connected on the entire circumference of the outer edge portion of the outer circumference of the second conductive film 47 formed on the second reflective film 45, and the second reflective film 45, the second conductive film 47, and the second drive electrode 46 are electrically connected together, thereby providing electrical conduction. In this way, since the second drive electrode 46 is in contact with the entire circumference of the outer edge portion of the second conductive film 47, it is possible to decrease electrical resistance in wiring connection, and to perform satisfactory connection.

The holding portion 42 is a diaphragm which surrounds the periphery of the movable portion 41, and is formed to have a thickness smaller than the movable portion 41. The holding portion 42 is bent more easily than the movable portion 41, is displaced by slight electrostatic attraction, and holds the movable portion 41 to be retreatable toward the fixed substrate 30. At this time, since the movable portion 41 has a thickness greater than the holding portion 42, and increases in rigidity, even when the holding portion 42 is stretched toward the fixed substrate 30 by electrostatic attraction, change in the shape of the movable portion 41 is suppressed. Accordingly, bending of the second reflective film 45 provided in the movable portion 41 is suppressed, making it possible to maintain the first reflective film 35 and the second reflective film 45 in a parallel state.

In this embodiment, although the holding portion 42 of the diaphragm is illustrated, the invention is not limited thereto, and for example, a configuration in which a beam-like holding portion is provided at an equal angle interval centering on the filter center point O, or the like may be used.

### Configuration of Voltage Control Unit

Returning to FIG. 1, the voltage control unit 15 is connected to the electrode pads 38b and 48b of the wavelength variable interference filter 5.

When a voltage command signal corresponding to a wavelength to be measured is received from the control unit 20, the voltage control unit 15 applies a corresponding voltage between the electrode pads 38b and 48b. Accordingly, electrostatic attraction based on the applied voltage is generated in the electrostatic actuator (between the first drive electrode 36 and the second drive electrode 46) of the wavelength variable interference filter 5, and the movable portion 41 is displaced toward the fixed substrate 30 to change the amount of the gap between the reflective films.

### Configuration of Control Unit

For example, the control unit 20 is constituted by combining a CPU, a memory, and the like, and controls the overall operation of the spectroscopic measurement apparatus 1. As shown in FIG. 1, the control unit 20 includes a wavelength setting unit 21, a light amount acquisition unit 22, and a spectroscopic measurement unit 23.

The control unit 20 includes a storage unit 24 which stores various kinds of data, and the storage unit 24 stores V-λ (voltage-wavelength) data for controlling the electrostatic actuator.

V-λ data is data which represents the relationship between the voltage (V) to be applied to the electrostatic actuator and the peak wavelength (λ) of light transmitting through the wavelength variable interference filter 5.

The wavelength setting unit 21 sets a target wavelength of light to be extracted by the wavelength variable interference filter 5, and also reads a target voltage value corresponding to the set target wavelength from V-λ data stored in the storage unit 24. The wavelength setting unit 21 outputs a control signal to the effect of applying the read target voltage value to the voltage control unit 15. Accordingly, the voltage of the target voltage value is applied from the voltage control unit 15 to the electrostatic actuator.

The light amount acquisition unit 22 acquires the amount of light having the target wavelength transmitting through the wavelength variable interference filter 5 on the basis of the amount of light acquired by the detector 11.

The spectroscopic measurement unit 23 measures a spectral characteristic of light to be measured on the basis of the amount of light acquired by the light amount acquisition unit 22.

As a spectroscopic measurement method in the spectroscopic measurement unit 23, for example, there is a method which measures a spectroscopic spectrum with the amount of light detected by the detector 11 for the wavelength to be measured as the amount of light of the wavelength to be measured, or a method which estimates a spectroscopic spectrum on the basis of the amount of light having a plurality of wavelengths to be measured.

As a method of estimating a spectroscopic spectrum, for example, a measurement spectrum matrix with the amount of light for a plurality of wavelengths to be measured as matrix elements is produced, and a predetermined transformation matrix is applied to the measurement spectrum matrix to estimate a spectroscopic spectrum of light to be measured. In this case, a plurality of kinds of sample light with a known spectroscopic spectrum are measured by the spectroscopic measurement apparatus 1, and a transformation matrix is set such that the deviation between a matrix in which a transformation matrix is applied to a measurement spectrum matrix produced on the basis of the amount of light obtained by measurement and a known spectroscopic spectrum is minimized.

### Method of Manufacturing Wavelength Variable Interference Filter

Next, a method of manufacturing the above-described wavelength variable interference filter 5 will be described referring to the drawings. Manufacturing of the wavelength variable interference filter 5 is composed of a manufacturing process of a fixed substrate, a manufacturing process of a movable substrate, and a bonding process of substrates.

### Manufacturing Process of Fixed Substrate

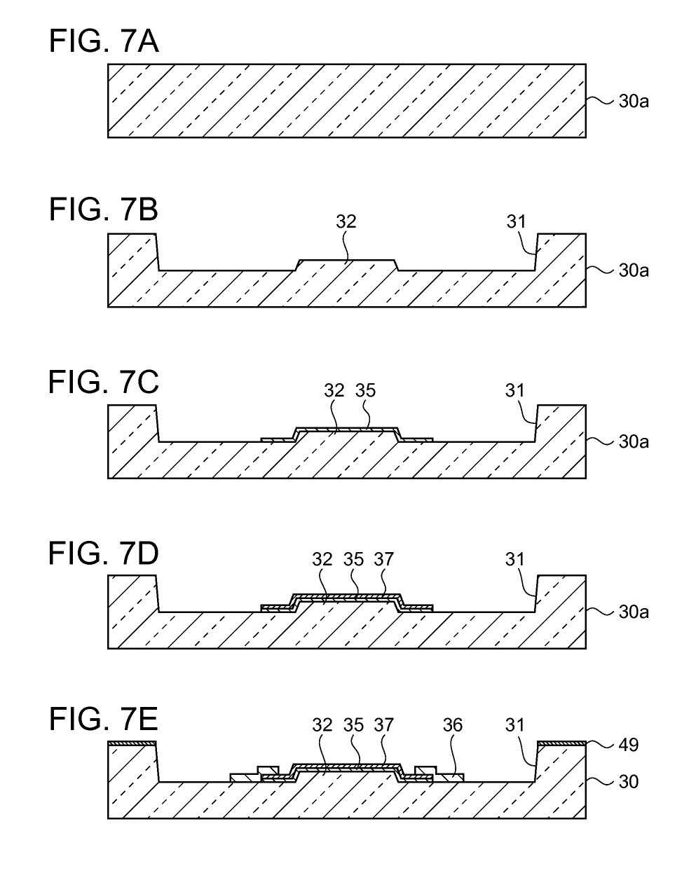

FIGS. 7A to 7E are explanatory views showing a manufacturing process of a fixed substrate.

First, as shown in FIG. 7A, a first base material 30a formed of a quartz glass substrate or the like as a material of the fixed substrate 30 is prepared, and both surfaces of the first base material 30a are subjected to precision polishing until surface roughness Ra becomes equal to or smaller than 1 nm.

Next, as shown in FIG. 7B, the substrate surface of the first base material 30a is processed by etching.

Specifically, resist is coated on the substrate surface of the first base material 30a, and the coated resist is exposed and developed by a photolithography method to pattern an opening for forming the concave portion 31 and the convex portion 32.

For example, both surfaces of the first base material 30a are subjected to wet etching using a hydrofluoric acid-based solution. At this time, etching up to the top surface of the convex portion 32 is performed. Thereafter, an opening for etching the concave portion 31 at a predetermined depth is patterned with resist, and wet etching is performed.

Accordingly, as shown in FIG. 7B, the first base material 30a in which the exterior shape of the fixed substrate 30 is determined is formed.

Next, as shown in FIG. 7C, the first reflective film 35 which extends from the top surface of the convex portion 32 to the bottom surface of the concave portion 31 is formed.

In this embodiment, an Ag film or an Ag alloy film is used as the first reflective film 35. When an Ag film or an Ag alloy film is used as the first reflective film 35, the film layer of the first reflective film 35 is formed in the concave portion 31 of the first base material 30a by a vacuum vapor deposition method or a sputtering method. Thereafter, the shape of the first reflective film 35 is formed using a photolithography method. Etching of an Ag film or an Ag alloy film is performed using an aqueous solution of phosphoric-nitric-acetic acid.

As shown in FIG. 7D, the first conductive film 37 is formed on the first reflective film 35. The first conductive film 37 is formed in the same shape as the first reflective film 35.

In this embodiment, an ITO film is used as the first conductive film 37. The film layer of the first conductive film 37 is formed in the concave portion 31 of the first base material 30a by a sputtering method. Thereafter, the shape of the first conductive film 37 is formed using a photolithography method. An acidic solution is used for etching of the ITO film.

Next, an electrode material which forms the first drive electrode 36, the lead-out electrode 38a, and the electrode pad 38b is formed in the concave portion 31 of the first base material 30a from the top of the first conductive film 37 using a vapor deposition method, a sputtering method, or the like. After the Cr film is formed as the underlayer, the Au film is formed as the electrode layer. Patterning is performed using a photolithography method, whereby, as shown in FIG. 7E, the first drive electrode 36, the lead-out electrode 38a, and the electrode pad 38b are formed.

Etching of the Au film is performed using a mixture of iodine and potassium iodide, and etching of the Cr film is performed using an aqueous solution of ceric ammonium nitrate.

In FIG. 7E, the lead-out electrode 38a and the electrode pad 38b are not shown.

Since the thickness of the first drive electrode 36 is greater than the thickness of the first reflective film 35, the step from the fixed substrate 30 by the first reflective film 35 is covered, whereby it is possible to prevent disconnection in the step portion.

Since the first conductive film 37 is formed on the first reflective film 35, it is possible to prevent the first reflective film 35 from being damaged by a chemical or the like in a process for forming the first drive electrode 36.

The bonding film 49 made of a plasma polymerized film or the like primarily containing siloxane is formed on the top surface (the surface in contact with the movable substrate 40) of the first base material 30a. The bonding film 49 is formed by, for example, a plasma CVD method or the like. It is preferable that the thickness of the bonding film 49 is, for example, 10 nm to 1000 nm.

In this way, the fixed substrate 30 is manufactured.

### Manufacturing Process of Movable Substrate

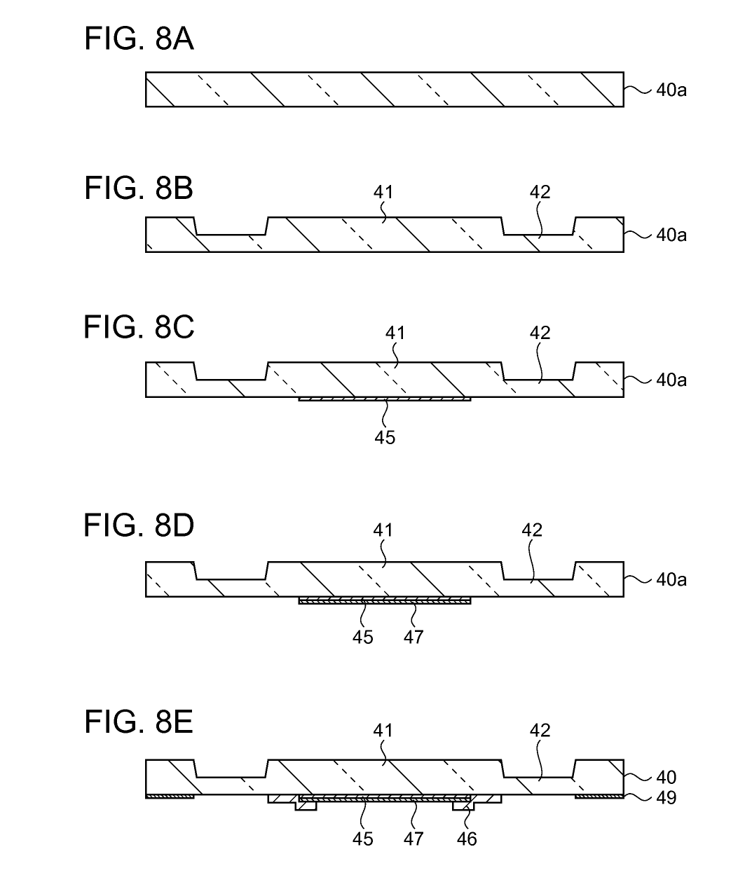

Next, a manufacturing process of a movable substrate will be described. FIGS. 8A to 8E are diagrams showing a manufacturing process of a movable substrate.

First, as shown in FIG. 8A, a second base material 40a which is formed of a quartz glass substrate or the like as a material of the movable substrate 40 is prepared, and both surfaces of the second base material 40a are subjected to precision polishing until surface roughness Ra becomes equal to or smaller than 1 nm.

Resist is coated on the entire surface of the second base material 40a, and the coated resist is exposed and developed by a photolithography method to pattern a location where the holding portion 42 is formed.

Next, similarly to the first base material 30a, the second base material 40a is subjected to wet etching using a hydrofluoric acid-based solution, whereby, as shown in FIG. 8B, the movable portion 41 and the holding portion 42 are formed. Accordingly, the second base material 40a in which the substrate shape of the movable substrate 40 is determined is manufactured.

Next, as shown in FIG. 8C, the second reflective film 45 is formed in the central portion of the surface opposite to the surface of the second base material 40a on which the movable portion 41 and the holding portion 42 are formed.

In this embodiment, an Ag film or an Ag alloy film is used as the second reflective film 45. When an Ag film or an Ag alloy film is used as the second reflective film 45, the film layer of the second reflective film 45 is formed by a vacuum vapor deposition method or a sputtering method. Thereafter, the shape of the second reflective film 45 is formed using a photolithography method. Etching of the Ag film or the Ag alloy film is performed using an aqueous solution of phosphoric-nitric-acetic acid.

As shown in FIG. 8D, the second conductive film 47 is formed on the second reflective film 45. The second conductive film 47 is formed in the same shape as the second reflective film 45.

In this embodiment, an ITO film is used as the second conductive film 47. The film layer of the second conductive film 47 is formed on the second base material 40a by a sputtering method. Thereafter, the shape of the second conductive film 47 is formed using a photolithography method. Etching of the ITO film is performed using an acidic solution.

Next, an electrode material which forms the second drive electrode 46, the lead-out electrode 48a, and the electrode pad 48b is formed on the second base material 40a from the top of the second conductive film 47 by a vapor deposition method, a sputtering method, or the like. After a Cr film is formed as the underlayer, an Au film is formed as the electrode layer. Patterning is performed using a photolithography method, whereby, as shown in FIG. 8E, the second drive electrode 46, the lead-out electrode 48a, and the electrode pad 48b are formed.

Etching of the Au film is performed using a mixture of iodine and potassium iodide, and etching of the Cr film is performed using an aqueous solution of ceric ammonium nitrate.

In FIG. 8E, the lead-out electrode 48a and the electrode pad 48b are not shown.

Since the thickness of the second drive electrode 46 is greater than the thickness of the second reflective film 45, the step from the movable substrate 40 by the second reflective film 45 is covered, whereby it is possible to prevent disconnection in the step portion.

Since the second conductive film 47 is formed on the second reflective film 45, it is possible to prevent the second reflective film 45 from being damaged by a chemical or the like in a process for forming the second drive electrode 46.

The bonding film 49 made of a plasma polymerized film or the like primarily containing siloxane is formed on the top surface (the surface in contact with the fixed substrate 30) of the second base material 40a. The bonding film 49 is formed by, for example, a plasma CVD method or the like. It is preferable that the thickness of the bonding film 49 is, for example, 10 nm to 1000 nm.

In this way, the movable substrate 40 is manufactured.

### Bonding Process of Substrates

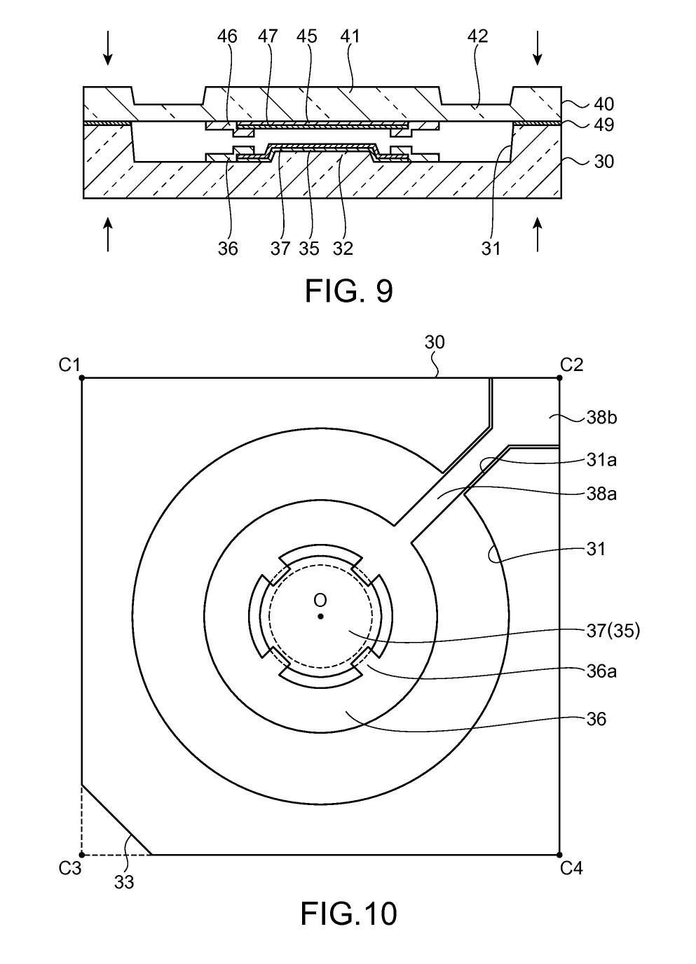

Next, a bonding process of substrates will be described. FIG. 9 is an explanatory view showing a bonding process of a fixed substrate and a movable substrate.

First, in order to give activation energy to the bonding film 49 of the fixed substrate 30 and the movable substrate 40, O₂ plasma treatment, N₂ plasma treatment, or UV treatment is performed.

After activation energy is given to the plasma polymerized film, alignment adjustment of the fixed substrate and the movable substrate 40 is performed, the fixed substrate 30 and the movable substrate 40 are superimposed through the bonding film 49, and a load is applied to the bonded portion. Accordingly, the fixed substrate 30 and the movable substrate 40 are bonded together.

Through the above-described process, the wavelength variable interference filter 5 is manufactured.

### Functional Effects of First Embodiment

As described above, in the wavelength variable interference filter 5 according to this embodiment, the first conductive film 37 which covers the first reflective film 35 is formed, and the first drive electrode 36 having a thickness greater than the sum of the thickness of the first reflective film 35 and the thickness of the first conductive film 37 is formed from the top of the first conductive film 37.

In this way, since the thickness of the first drive electrode 36 is greater than the thickness of the first reflective film 35, the step from the fixed substrate 30 by the first reflective film 35 is covered, whereby it is possible to prevent disconnection in the step portion.

The second conductive film 47 which covers the second reflective film 45 is formed, and the second drive electrode 46 having a thickness greater than the sum of the thickness of the second reflective film 45 and the thickness of the second conductive film 47 is formed from the top of the second conductive film 47.

In this way, since the thickness of the second drive electrode 46 is greater than the thickness of the second reflective film 45, the step from the movable substrate 40 by the second reflective film 45 is covered, whereby it is possible to prevent disconnection in the step portion.

The first conductive film 37 and the second conductive film 47 are provided, whereby it is possible to prevent Ag atoms of the first reflective film 35 and the second reflective film 45 from being diffused to the Cr film and the Au film of the first drive electrode 36 and the second drive electrode 46, and to suppress disconnection of wiring.

From this, it is possible to reliably provide electrical conduction between the first reflective film 35 and the first drive electrode 36 and electrical conduction between the second reflective film 45 and the second drive electrode 46, and to improve connection reliability of wiring.

The materials of the first conductive film 37 and the second conductive film 47 are materials selected from indium-based oxide, tin-based oxide, zinc-based oxide, and a mixture thereof.

These materials are used as the first conductive film 37 and the second conductive film 47, whereby it is possible to effectively prevent diffusion from the first reflective film 35 and the second reflective film 45 to the first drive electrode 36 and the second drive electrode 46. With the use of these materials, it is possible to protect the first reflective film 35 and the second reflective film 45 from a chemical in the manufacturing process.

Since the optical module 10 according to this embodiment includes the wavelength variable interference filter 5 which improves connection reliability of wiring, it is possible to improve reliability of the optical module 10.

Since the spectroscopic measurement apparatus 1 as an electronic apparatus includes the wavelength variable interference filter 5 which improves connection reliability of wiring, it is possible to improve reliability of the spectroscopic measurement apparatus 1.

### Modification Example of Connection State of Drive Electrode and Conductive Film

Next, a modification example of the connection state of the drive electrode (first drive electrode and second drive electrode) and the conductive film (first conductive film and second conductive film) formed on the reflective film (first reflective film and second reflective film) in the wavelength variable interference filter 5 will be described. Although the drive electrode, the reflective film, and the conductive film are provided on each of the fixed substrate 30 and the movable substrate 40, here, the fixed substrate 30 side will be described. The same parts as those in the first embodiment are represented by the same reference numerals, and description thereof will not be repeated.

FIG. 10 is a plan view showing a modification example of the shape of the first drive electrode in the first embodiment.

In this modification example, the shape of the first drive electrode is different from that in the first embodiment.

The first drive electrode 36 formed on the fixed substrate 30 has a plurality of extended portions 36a which are formed to extend from the ring-shaped inner edge, and each extended portion 36a is in contact with the first conductive film 37.

In this case, electrical conduction with the first conductive film 37 may be provided using the first drive electrode 36 having the above-described shape, and the same effects as in the first embodiment can be obtained.

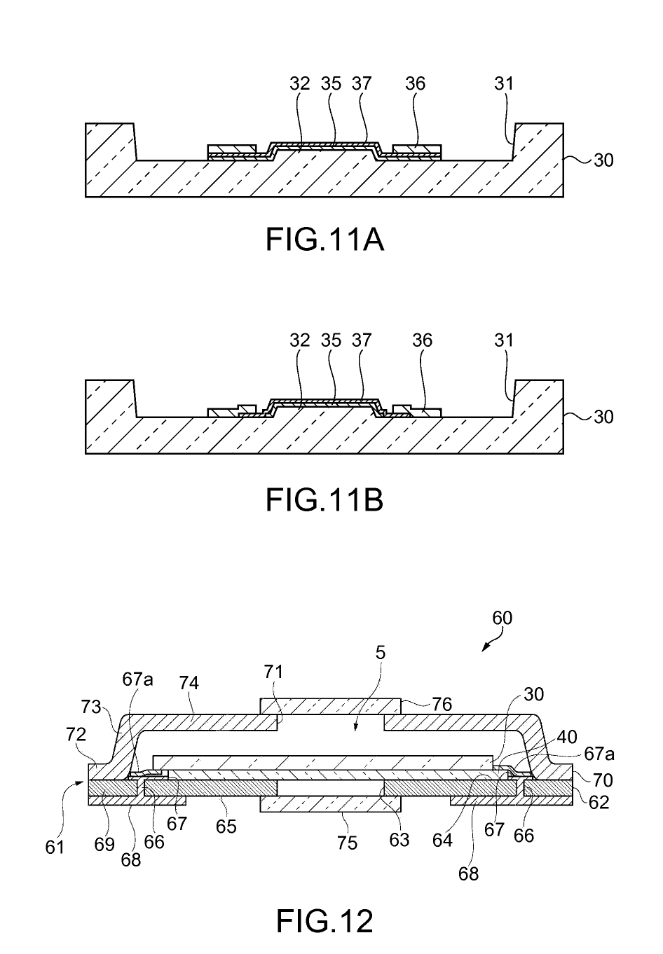

FIGS. 11A and 11B are sectional views of the fixed substrate showing a modification example of the contact state of the first drive electrode and the first conductive film in the first embodiment.

As shown in FIG. 11A, the first reflective film 35 and the first conductive film 37 are formed in a circular shape from the center of the fixed substrate 30 to the bottom surface of the concave portion 31. The ring-shaped first drive electrode 36 is formed along the outer circumferential portion of the first conductive film 37 in a state of being placed on the first conductive film 37. In this way, the contact area of the first drive electrode 36 and the first conductive film 37 is increased, whereby it is possible to decrease electrical resistance in wiring connection, and to perform satisfactory connection.

As shown in FIG. 11B, the first conductive film 37 is formed to overlap the first reflective film 35 with an area greater than the first reflective film 35 provided at the center of the fixed substrate 30. The first conductive film 37 is in contact with the first drive electrode 36 in the outer edge portion of the first conductive film 37 which does not overlap the first reflective film 35 in plan view. In this way, the first conductive film 37 can be formed to the lateral surface of the outer edge portion of the first reflective film 35, a portion where a chemical is in contact with the first reflective film 35 in the manufacturing process of the first drive electrode 36 is eliminated, and there is no damage to the first reflective film 35.

In the foregoing embodiment and the modification example, although an example where both the fixed substrate 30 and the movable substrate 40 have the drive electrode and the reflective film of the same configuration has been described, both may not have the same structure, or the structure described in the first embodiment and the modification example may be combined.

Although the first drive electrode as the first connection electrode which is connected to the first reflective film and the second drive electrode as the second connection electrode which is connected to the second reflective film have been described, the invention is not limited to this example, and as a connection electrode which is connected to a reflective film, a monitoring electrode for measuring electrostatic capacitance or the like may be connected to a reflective film.

### Second Embodiment

Next, a second embodiment of the invention will be described referring to the drawings.

In the spectroscopic measurement apparatus 1 of the first embodiment, the wavelength variable interference filter 5 is provided directly in the optical module 10. However, an optical module has a complicated configuration, and in particular, it is difficult to provide the wavelength variable interference filter 5 directly in a small optical module. In this embodiment, an optical filter device in which the wavelength variable interference filter 5 can be easily provided in an optical module will be described below.

FIG. 12 is a sectional view showing the schematic configuration of an optical filter device according to the second embodiment of the invention.

As shown in FIG. 12, an optical filter device 60 includes a wavelength variable interference filter 5, and a housing 61 which stores the wavelength variable interference filter 5.

The housing 61 includes a base substrate 62, a lid 70, a base-side glass substrate 75, and a lid-side glass substrate 76.

The base substrate 62 is made of, for example, a single-layer ceramic substrate. The base substrate 62 is provided with a movable substrate 40 of the wavelength variable interference filter 5. As the installation of the movable substrate 40 on the base substrate 62, for example, the movable substrate 40 may be arranged on the base substrate 62 through an adhesive layer or the like, or the movable substrate 40 may be arranged on the base substrate 62 by engagement with a different fixing member or the like, or the like. A light passage hole 63 is formed in the base substrate 62. The base-side glass substrate 75 is bonded so as to cover the light passage hole 63. As a method of bonding the base-side glass substrate 75, for example, glass frit bonding using glass frit which is a piece of broken glass obtained by melting a glass raw material at high temperature and performing rapid cooling, or adhesion by epoxy resin or the like may be used.

On a base inner surface 64 of the base substrate 62 facing the lid 70, inner terminal portions 67 are provided corresponding to the respective electrode pads of the wavelength variable interference filter 5. The connection of the respective electrode pads and the inner terminal portions 67 may be carried out using, for example, FPC67a, and for example, Ag paste, an ACF (Anisotropic Conductive Film), ACP (Anisotropic Conductive Paste), or the like is used for bonding. The connection of the respective electrode pads and the inner terminal portions 67 is not limited to the connection by FPC67a, and for example, wiring connection by wire bonding or the like may be carried out.

In the base substrate 62, through holes 66 are formed corresponding to the positions where the respective inner terminal portions 67 are provided, and the respective inner terminal portions 67 are connected to outer terminal portions 68, which are provided on a base outer surface 65 opposite to the base inner surface 64 of the base substrate 62, through conductive members filled in the through holes 66.

In the outer circumferential portion of the base substrate 62, a base bonding portion 69 which is bonded to the lid 70 is provided.

As shown in FIG. 12, the lid 70 includes a lid bonding portion 72 which is bonded to the base bonding portion 69 of the base substrate 62, a sidewall portion 73 which is continuous from the lid bonding portion 72 and stands up in a direction away from the base substrate 62, and a top surface portion 74 which is continuous from the sidewall portion 73 and covers the fixed substrate 30 side of the wavelength variable interference filter 5. The lid 70 may be formed of, for example, an alloy or a metal, such as kovar.

The lid 70 is bonded closely to the base substrate 62 by bonding the lid bonding portion 72 and the base bonding portion 69 of the base substrate 62.

As the bonding method, for example, laser welding, soldering using silver solder or the like, sealing using an eutectic alloy layer, welding using low-melting-point glass, glass adhesion, glass frit bonding, bonding by epoxy resin, and the like are illustrated. These bonding methods may be appropriately selected by the materials of the base substrate 62 and the lid 70, the bonding environment, or the like.

The top surface portion 74 of the lid 70 is parallel to the base substrate 62. In the top surface portion 74, a light passage hole 71 is formed. The lid-side glass substrate 76 is bonded so as to cover the light passage hole 71. As a method of bonding the lid-side glass substrate 76, similarly to the bonding of the base-side glass substrate 75, for example, glass frit bonding or adhesion by epoxy resin or the like may be used.

In the optical filter device 60 of this embodiment as described above, since the wavelength variable interference filter 5 is protected by the housing 61, it is possible to prevent damage to the wavelength variable interference filter 5 by external factors.

### Third Embodiment

Next, an electronic apparatus which uses the wavelength variable interference filter described in the first embodiment will be described. In a third embodiment, for example, a colorimetric apparatus which measures chromaticity of an object to be measured will be described.

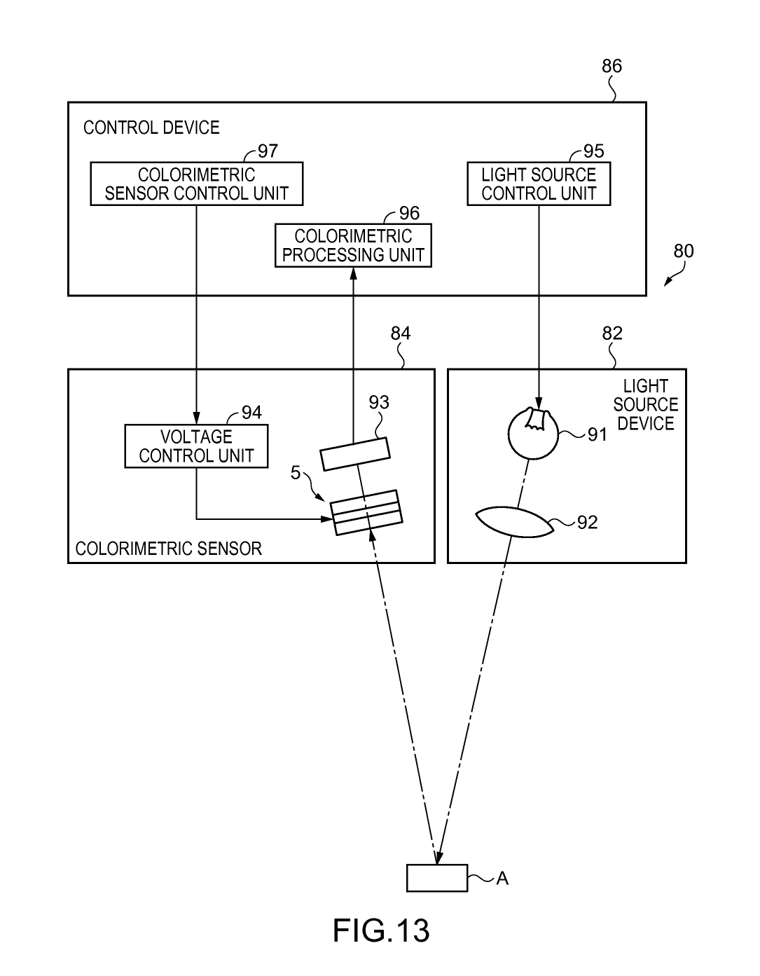

FIG. 13 is a schematic view showing a configuration of a colorimetric apparatus.

A colorimetric apparatus 80 includes a light source device 82 which irradiates light on a test object A, a colorimetric sensor 84 (optical module), a control device 86 which controls the overall operation of the colorimetric apparatus 80.

The colorimetric apparatus 80 is an apparatus which irradiates light onto the test object A from the light source device 82, receives light to be tested reflected by the test object A by the colorimetric sensor 84, and analyzes and measures chromaticity of light to be tested on the basis of a detection signal output from the colorimetric sensor 84.

The light source device 82 includes a light source 91 and a plurality of lenses 92 (in FIG. 13, only one lens is shown), and emits white light to the test object A. A plurality of lenses 92 may include a collimator lens, and in this case, the light source device 82 parallelizes light emitted from the light source 91 by the collimator lens to form parallel light, and emits parallel light from a projection lens (not shown) toward the test object A.

In this embodiment, although the colorimetric apparatus 80 including the light source device 82 is illustrated, for example, when the test object A is a light emitting member, a colorimetric apparatus may have a configuration in which the light source device 82 is not provided.

The colorimetric sensor 84 as an optical module includes the wavelength variable interference filter 5, a voltage control unit 94 which controls a voltage to be applied to the electrostatic actuator and changes the wavelength of light transmitting through the wavelength variable interference filter 5, and a light receiving unit 93 (detection unit) which receives light transmitting through the wavelength variable interference filter 5.

The colorimetric sensor 84 includes an optical lens (not shown) which guides reflected light (light to be tested) reflected by the test object A to the wavelength variable interference filter 5. The colorimetric sensor 84 disperses light to be tested entering the optical lens to light in a predetermined wavelength band by the wavelength variable interference filter 5, and the dispersed light is received by the light receiving unit 93.

The light receiving unit 93 has a photoelectric conversion element, such as a photodiode, as a detection unit, and produces an electrical signal according to the amount of received light. The light receiving unit 93 is connected to the control device 86, and outputs the produced electrical signal to the control device 86 as a light reception signal.

The voltage control unit 94 controls the voltage to be applied to the electrostatic actuator on the basis of a control signal input from the control device 86.

The control device 86 controls the overall operation of the colorimetric apparatus 80. As the control device 86, for example, a general-purpose personal computer, a portable information terminal, or colorimetry dedicated computer, or the like may be used.

The control device 86 includes alight source control unit 95, a colorimetric sensor control unit 97, a colorimetric processing unit 96 (analysis processing unit), and the like.

The light source control unit 95 is connected to the light source device 82. The light source control unit 95 outputs a predetermined control signal to the light source device 82 on the basis of, for example, a setting input of a user, and causes the light source device 82 to emit white light with predetermined brightness.

The colorimetric sensor control unit 97 is connected to the colorimetric sensor 84. For example, the colorimetric sensor control unit 97 sets the wavelength of light received by the colorimetric sensor 84 on the basis of the setting input of the user, and outputs a control signal to the effect of detecting the amount of received light having this wavelength to the colorimetric sensor 84. Accordingly, the voltage control unit 94 of the colorimetric sensor 84 sets the voltage to be applied to the electrostatic actuator on the basis of the control signal so as to transmit the wavelength of light desired by the user.

The calorimetric processing unit 96 performs control such that the colorimetric sensor control unit 97 changes the gap dimension between the reflective films of the wavelength variable interference filter 5 to change the wavelength of light transmitting through the wavelength variable interference filter 5. The colorimetric processing unit 96 acquires the amount of light transmitting through the wavelength variable interference filter 5 on the basis of the light reception signal input from the light receiving unit 93. The colorimetric processing unit 96 calculates chromaticity of light reflected by the test object A on the basis of the amount of received light having each wavelength obtained in the above-described manner.

In this way, since the colorimetric apparatus 80 as an electronic apparatus and the colorimetric sensor 84 as an optical module of this embodiment include the wavelength variable interference filter 5 which improves connection reliability of wiring, it is possible to improve reliability of the colorimetric sensor 84.

In the third embodiment, although the colorimetric apparatus 80 has been illustrated as an electronic apparatus, a wavelength variable interference filter, an optical module, and an electronic apparatus may be used in various fields.

For example, it is possible to use a light-based system for detecting the presence of a specific substance. As such a system, for example, a gas detection apparatus, such as an in-vehicle gas leakage detector which detects specific gas using a spectroscopic measurement system having a wavelength variable interference filter with high sensitivity, or a photoacoustic rare gas detector for a breath test, may be illustrated.

### Fourth Embodiment

Hereinafter, an example of a gas detection apparatus will be described below referring to the drawings.

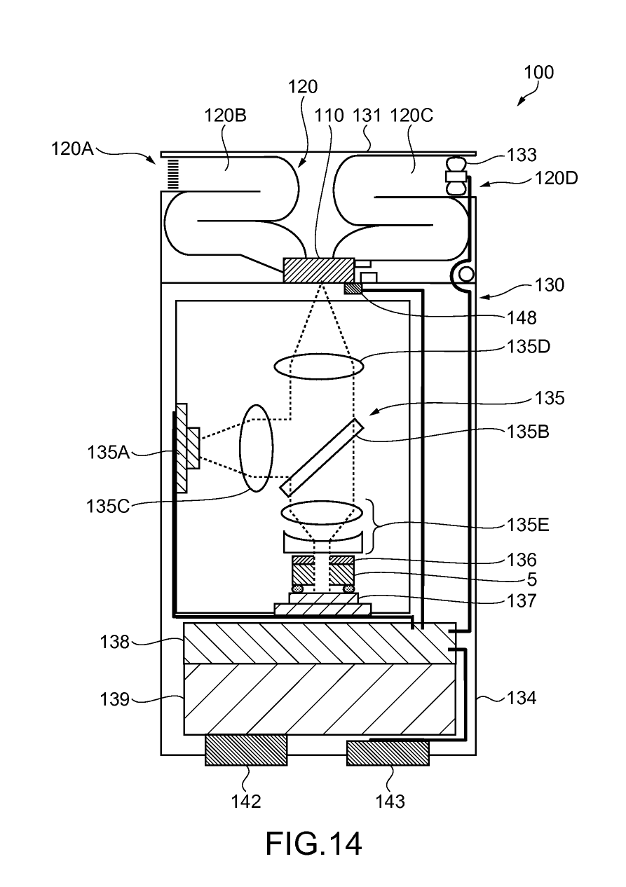

FIG. 14 is a schematic view showing an example of a gas detection apparatus having a wavelength variable interference filter.

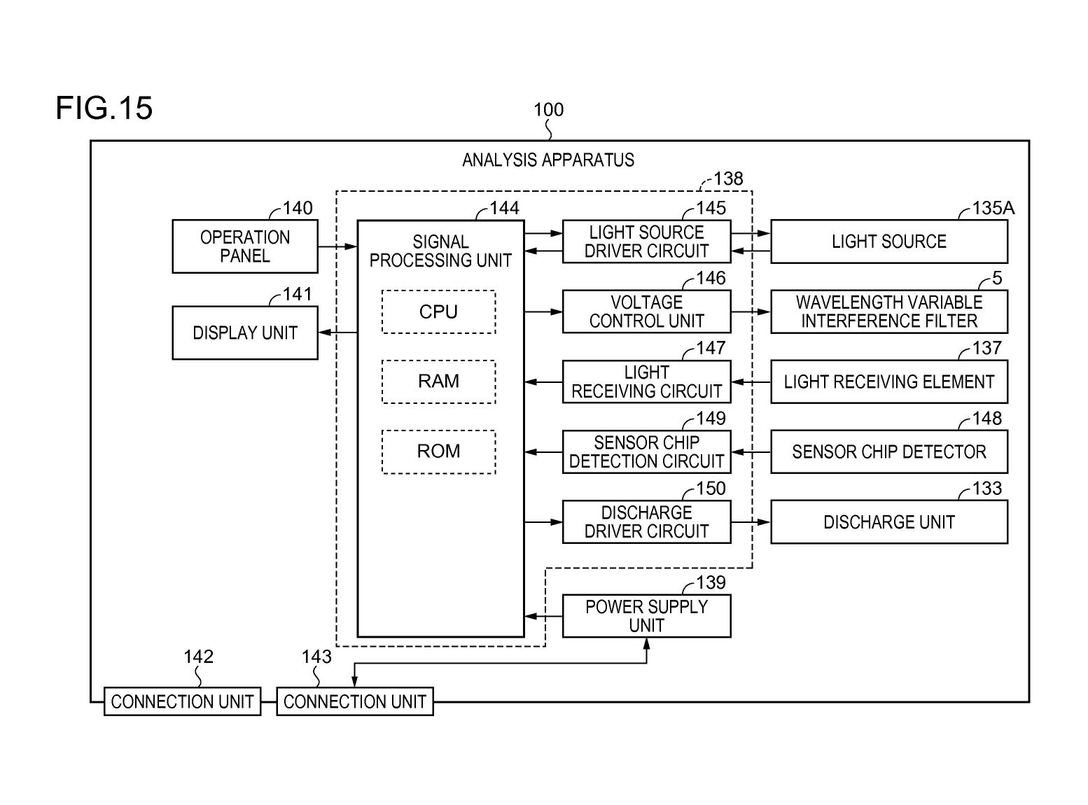

FIG. 15 is a block diagram showing a configuration of a control system of the gas detection apparatus.

As shown in FIG. 14, a gas detection apparatus 100 includes a sensor chip 110, a flow channel 120 including a suction port 120A, a suction flow channel 120B, a discharge flow channel 120C, and a discharge port 120D, and a body portion 130.

The body portion 130 includes a detection unit (optical module) which includes a sensor unit cover 131 having an opening for allowing the attachment/detachment of the flow channel 120, a discharge unit 133, a housing 134, an optical unit 135, a filter 136, a wavelength variable interference filter 5, a light receiving element 137 (light receiving unit), and the like, a control unit 138 which processes a detected signal and controls the detection unit, a power supply unit 139 which supplies power, and the like. The optical unit 135 has a light source 135A which emits light, a beam splitter 135B which reflects light entering from the light source 135A toward the sensor chip 110 and transmits light entering from the sensor chip side toward the light receiving element 137, and lenses 135C, 135D, and 135E.

As shown in FIG. 15, the gas detection apparatus 100 is provided with an operation panel 140, a display unit 141, a connection unit 142 for interface with the outside, and the power supply unit 139. When the power supply unit 139 is a secondary battery, the power supply unit 139 may include a connection unit 143 for charging.

The control unit 138 of the gas detection apparatus 100 includes a signal processing unit 144 which is constituted by a CPU or the like, a light source driver circuit 145 which controls the light source 135A, a voltage control unit 146 which controls the wavelength variable interference filter 5, a light receiving circuit 147 which receives a signal from the light receiving element 137, a sensor chip detection circuit 149 which reads a code of the sensor chip 110 and receives a signal from a sensor chip detector 148 detecting the presence/absence of the sensor chip 110, a discharge driver circuit 150 which controls the discharge unit 133, and the like.

Next, an operation of the gas detection apparatus 100 will be described below.

The sensor chip detector 148 is provided inside the sensor unit cover 131 in an upper portion of the body portion 130, and the presence/absence of the sensor chip 110 is detected by the sensor chip detector 148. When a detection signal from the sensor chip detector 148 is detected, the signal processing unit 144 determines that the sensor chip 110 is loaded, and outputs, to the display unit 141, a display signal for displaying to the effect that a detection operation is executable.

For example, if the operation panel 140 is operated by the user, and an instruction signal to the effect of starting detection processing is output from the operation panel 140 to the signal processing unit 144, first, the signal processing unit 144 outputs a source actuation signal to the light source driver circuit 145 to actuate the light source 135A. If the light source 135A is driven, stable laser light linearly polarized with a single wavelength is emitted from the light source 135A. The light source 135A is embedded with a temperature sensor and a light amount sensor, and information is output to the signal processing unit 144. If it is determined on the basis of the temperature and the amount of light input from the light source 135A that the light source 135A performs stable operation, the signal processing unit 144 performs control such that the discharge driver circuit 150 actuates the discharge unit 133. Accordingly, a gas sample including a target substance (gas molecule) to be detected is induced from the suction port 120A to the discharge port 120D through the suction flow channel 120B inside the sensor chip 110 and the discharge flow channel 120C.

The sensor chip 110 is a sensor which has a plurality of metal nanostructurs embedded therein, and uses localized surface plasmon resonance. In the sensor chip 110, an enhanced electric field is formed between the metal nanostructures by laser light, and if a gas molecule enters the enhanced electric field, Raman scattering light including information of molecular vibration and Rayleigh scattering light are generated.

Rayleigh scattering light or Raman scattering light enters the filter 136 through the optical unit 135, Rayleigh scattering light is separated by the filter 136, and Raman scattering light enters the wavelength variable interference filter 5. The signal processing unit 144 performs control such that the voltage control unit 146 adjusts the voltage to be applied to the wavelength variable interference filter 5 and disperses Raman scattering light corresponding to a gas molecule to be detected by the wavelength variable interference filter 5. Thereafter, if the dispersed light is received by the light receiving element 137, a light reception signal according to the amount of received light is output to the signal processing unit 144 through the light receiving circuit 147.

The signal processing unit 144 compares spectrum data of Raman scattering light corresponding to the gas molecule to be detected obtained in the above-described manner with data stored in the ROM, determines whether or not the gas molecule is a target gas molecule, and specifies a substance. The signal processing unit 144 causes the display unit 141 to display result information, or outputs the result information from the connection unit 142 to the outside.

In FIGS. 14 and 15, although the gas detection apparatus 100 which disperses Raman scattering light by the wavelength variable interference filter 5 and performs gas detection from the dispersed Raman scattering light has been illustrated, the gas detection apparatus may be used as a gas detection apparatus which detects absorbance specific to gas to specify a gas type. In this case, a gas sensor which causes gas to flow inside the sensor and detects light absorbed by gas out of incoming light is used as an optical module according to the invention. The gas detection apparatus 100 which analyzes and discriminates gas flowing inside the sensor by the gas sensor is an electronic apparatus according to the invention. In this configuration, it is also possible to detect a component of gas using a wavelength variable interference filter according to the invention.

A system for detecting the presence of a specific material is not limited to gas detection as described above, and a substance component analysis apparatus, such as a non-invasive measurement apparatus of saccharides by near-infrared spectroscopy, or a non-invasive measurement apparatus of information regarding foods, living bodies, minerals, and the like may be illustrated.

### Fifth Embodiment

Next, as an example of the substance component analysis apparatus, a food analysis apparatus will be described.

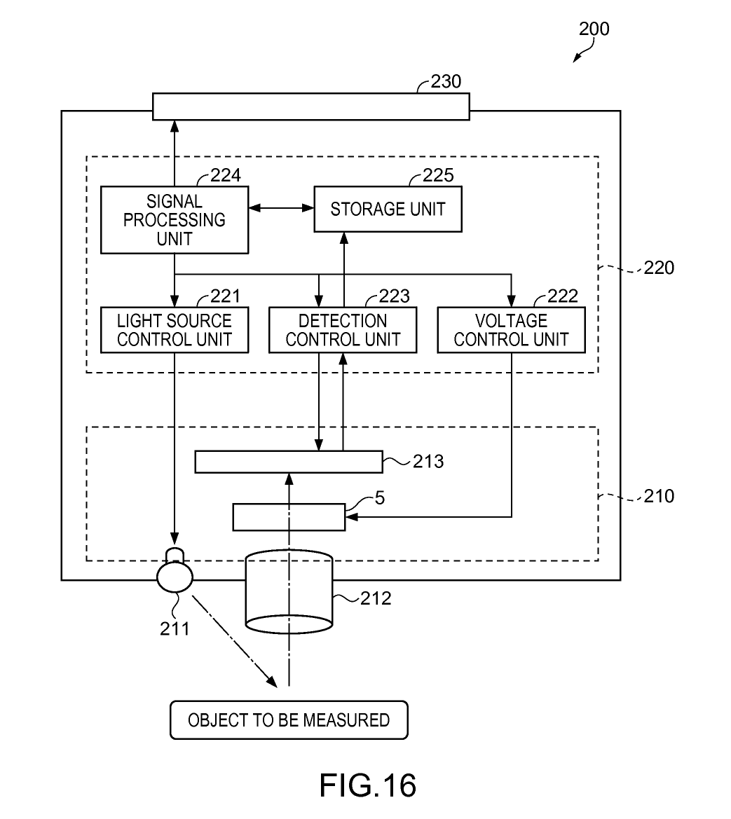

FIG. 16 is a schematic view showing a configuration of the food analysis apparatus which is an example of an electronic apparatus using the wavelength variable interference filter 5.

A food analysis apparatus 200 includes a detector (optical module) 210, a control unit 220, and a display unit 230. The detector 210 includes a light source 211 which emits light, an imaging lens 212 to which light from an object to be measured is introduced, a wavelength variable interference filter 5 which disperses light introduced from the imaging lens 212, and an imaging unit (light receiving unit) 213 which detects the dispersed light.

The control unit 220 includes a light source control unit 221 which carries out turn-on/off control of the light source 211 and control of brightness during turn-on, a voltage control unit 222 which controls the wavelength variable interference filter 5, a detection control unit 223 which controls the imaging unit 213 and acquires a spectroscopic image imaged by the imaging unit 213, a signal processing unit 224, and a storage unit 225.

In the food analysis apparatus 200, if the apparatus is driven, the light source 211 is controlled by the light source control unit 221, and light is irradiated from the light source 211 onto the object to be measured. Light reflected by the object to be measured enters the wavelength variable interference filter 5 through the imaging lens 212. A voltage enough to disperse a desired wavelength is applied to the wavelength variable interference filter 5 under the control of the voltage control unit 222, and the dispersed light is imaged by the imaging unit 213 which is constituted by, for example, a CCD camera or the like. The imaged light is accumulated in the storage unit 225 as a spectroscopic image. The signal processing unit 224 performs control such that the voltage control unit 222 changes the voltage value to be applied to the wavelength variable interference filter 5 and acquires a spectroscopic image for each wavelength.

The signal processing unit 224 performs arithmetic processing on data of each pixel in each image accumulated in the storage unit 225 and obtains a spectrum in each pixel. The storage unit 225 stores, for example, information relating to a component of a food for a spectrum, and the signal processing unit 224 analyzes data of the obtained spectrum on the basis of information relating to a food stored in the storage unit 225, and obtains a food component included in an object to be detected and the content of the food component. It is also possible to calculate food calorie, freshness, and the like from the obtained food component and content. A spectral distribution in an image is analyzed, thereby extracting a portion where freshness is lowered in a food to be tested and detecting a foreign substance included in a food.

The signal processing unit 224 performs processing for causing the display unit 230 to display information regarding the obtained component or content of the food to be tested, calorie, freshness, and the like.

In FIG. 16, although an example of the food analysis apparatus 200 is shown, the substance component analysis apparatus may be used as a non-invasive measurement apparatus of other kinds of information with the substantially same configuration. For example, the substance component analysis apparatus may be used as a biological analysis apparatus which analyzes a biological component, for example, performs the measurement and analysis of a body fluid component, such as blood. Examples of the biological analysis apparatus include an apparatus which measures a body fluid component, such as blood, and if an apparatus is configured to detect ethyl alcohol, the substance component analysis apparatus may be used as a drunken driving prevention apparatus which detects a drinking state of a driver of a vehicle. The electronic apparatus may be used as an electronic endoscope system including the biological analysis apparatus.

The substance component analysis apparatus may also be used as a mineral analysis apparatus which carries out component analysis of minerals.

A wavelength variable interference filter, an optical module, and an electronic apparatus according to the invention may be applied to the following apparatuses.

For example, the intensity of light of each wavelength changes over time to transmit data by light of each wavelength. In this case, light having a specific wavelength is dispersed by a wavelength variable interference filter provided in an optical module, and is received by a light receiving unit, thereby extracting data to be transmitted by light having a specific wavelength. Data of light of each wavelength is processed by an electronic apparatus including an optical module for data extraction, thereby carrying out optical communication.

### Sixth Embodiment

The invention may be applied to other electronic apparatuses, for example, a spectroscopic camera which disperses light by a wavelength variable interference filter according to the invention and images a spectroscopic image, a spectrometer, and the like. As an example of such a spectroscopic camera, an infrared camera embedded with a wavelength variable interference filter is illustrated.

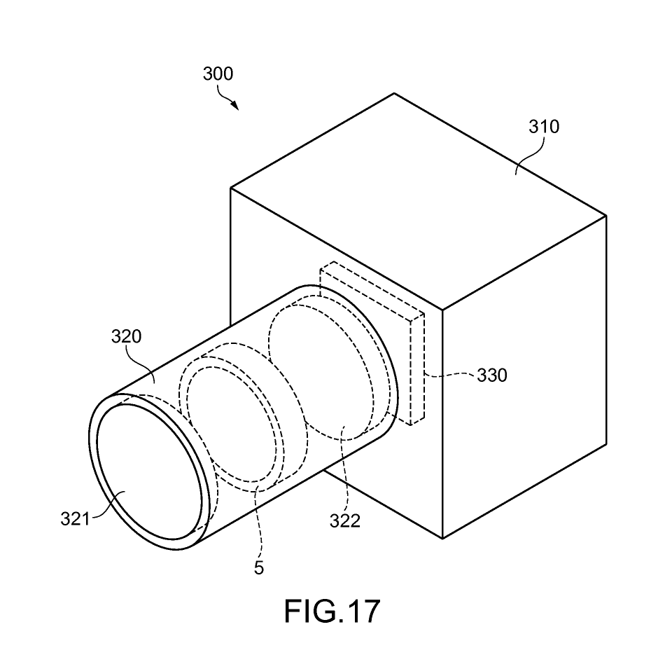

FIG. 17 is a perspective view showing a configuration of the spectroscopic camera. As shown in FIG. 17, a spectroscopic camera 300 includes a camera body 310, an imaging lens unit 320, and an imaging unit 330.

The camera body 310 is a portion which is held and operated by the user.

The imaging lens unit 320 is provided in a camera body 310, and guides incoming image light to the imaging unit 330. The imaging lens unit 320 includes an objective lens 321, an imaging lens 322, and a wavelength variable interference filter 5 provided between these lenses.

The imaging unit 330 is constituted by a light receiving element, and images image light guided by the imaging lens unit 320.

In the spectroscopic camera 300, light having a wavelength to be imaged transmits through the wavelength variable interference filter 5, thereby imaging a spectroscopic image of light having a desired wavelength.

A wavelength variable interference filter according to the invention may be used as a band-pass filter, and may be used as an optical laser apparatus which disperses and transmits only narrowband light centering on a predetermined wavelength out of light in a predetermined wavelength band emitted from a light emitting element.

A wavelength variable interference filter according to the invention may be used as a biological authentication apparatus, and may be applied to, for example, an authentication apparatus of a blood vessel, a fingerprint, a retina, an iris, or the like using light of a near-infrared region or a visible region.

An optical module and an electronic apparatus may be used as a concentration detection apparatus. In this case, infrared energy (infrared light) emitted from a substance is dispersed and analyzed by a wavelength variable interference filter to measure a subject concentration in a sample.

As described above, a wavelength variable interference filter, an optical module, and an electronic apparatus according to the invention may be applied to any apparatus which disperses predetermined light from incoming light. As described above, since a wavelength variable interference filter according to the invention can disperse a plurality of wavelengths by a single device, it is possible to carry out the measurement of the spectrum of a plurality of wavelengths and the detection of a plurality of components with high precision. Accordingly, compared to a related art apparatus which extracts a desired wavelength by a plurality of devices, it is possible to advance reduction in size of an optical module or an electronic apparatus, and to suitably use a wavelength variable interference filter, an optical module, and an electronic apparatus according to the invention for portable and in-vehicle apparatuses.

The invention is not limited to the embodiments described above, and a specific structure and procedure when carrying out the invention may be appropriately changed to other structures or the like within the scope capable of attaining the object of the invention. Then, many modification examples may be made by a person having ordinary skill in the art within the technical idea of the invention.

The entire disclosure of Japanese Patent Application No. 2013-032936 filed on Feb. 22, 2013 is expressly incorporated by reference herein.

What is claimed is:

1. A wavelength variable interference filter comprising:
a first substrate;
a second substrate which is arranged to face the first substrate;
a first reflective film which is provided on the first substrate;
a second reflective film which is provided on the second substrate and is arranged to face the first reflective film;
a first conductive film which is laminated on the first reflective film;
a second conductive film which is laminated on the second reflective film;
a first connection electrode which is provided on the first substrate and is electrically connected to the first conductive film on the first substrate; and
a second connection electrode which is provided on the second substrate and is electrically connected to the second conductive film on the second substrate,
wherein the thickness of the first connection electrode is greater than the sum of the thickness of the first reflective film and the thickness of the first conductive film,
the first connection electrode extends from the surface of the first substrate to the surface of the outer edge portion of the first conductive film and is in contact with the first conductive film,
the thickness of the second connection electrode is greater than the sum of the thickness of the second reflective film and the thickness of the second conductive film, and
the second connection electrode extends from the surface of the second substrate to the surface of the outer edge portion of the second conductive film and is in contact with the second conductive film.

2. The wavelength variable interference filter according to claim 1,
wherein at least one of the first connection electrode and the second connection electrode is in contact with the entire circumference of the outer edge portion of the first conductive film or the second conductive film.

3. The wavelength variable interference filter according to claim 1,
wherein the first conductive film and the second conductive film are transparent conductive films.

4. The wavelength variable interference filter according to claim 1,
wherein the materials of the first conductive film and the second conductive film are materials selected from indium-based oxide, tin-based oxide, zinc-based oxide, and a mixture thereof.

5. The wavelength variable interference filter according to claim 1,
wherein the materials of the first reflective film and the second reflective film are Ag or an alloy primarily containing Ag.

6. The wavelength variable interference filter according to claim 1,
wherein the second substrate includes
a movable portion which is provided with the second reflective film, and
a holding portion which is provided outside the movable portion in plan view when the second substrate is viewed in a substrate thickness direction, has a thickness smaller than the thickness of the movable portion, and retreatably holds the movable portion.

7. A wavelength variable interference filter comprising:
a reflective film which reflects apart of incoming light and transmits a part of incoming light;
a conductive film which is laminated on the reflective film;
a connection electrode which is electrically connected to the conductive film,
wherein the thickness of the connection electrode is greater than the sum of the thickness of the reflective film and the thickness of the conductive film, and
the connection electrode is in contact with the surface of the outer edge portion of the conductive film in an overlapping manner.

8. An optical filter device comprising:
the wavelength variable interference filter according to claim 1; and
a housing which stores the wavelength variable interference filter,

9. An optical module comprising:
the wavelength variable interference filter according to claim 1; and
a detection unit which detects light extracted by the first reflective film and the second reflective film,

10. An electronic apparatus comprising:
the wavelength variable interference filter according to claim 1; and
a control unit which controls the wavelength variable interference filter.
